(19) United States
(12) Patent Application Publication
(10) Pub. No.: US 2014/0193165 A1
(43) Pub. Date: Jul. 10, 2014

(54) ELECTRONIC ALIGNMENT OF OPTICAL SIGNALS

(71) Applicant: Silicon Image, Inc., Sunnyvale, CA (US)

(72) Inventor: Kihong Kim, Cupertino, CA (US)

(73) Assignee: Silicon Image, Inc., Sunnyvale, CA (US)

(21) Appl. No.: 13/844,152

(22) Filed: Mar. 15, 2013

Related U.S. Application Data
(60) Provisional application No. 61/750,219, filed on Jan. 8, 2013.

(51) Int. Cl. H04B 10/25

(52) U.S. Cl. CPC H04B 10/25
USPC 398/212

(57) ABSTRACT

Embodiments of the invention are generally directed to electronic alignment of optical signals. An embodiment of an apparatus includes an array of photo sensors; a bus coupled with the array, the bus including detection circuitry for each photo sensor to generate a signal in response to the photo sensor receiving an optical signal; and a processing component to process a group of signals, the group of signals being signals generated by the detection circuitry for a subset of the photo sensors in response to the photo sensors receiving the optical signal, to generate an output signal.

### CROSS-REFERENCE TO RELATED APPLICATION

This application claims the benefit of priority from U.S. Provisional Patent Application No. 61/750,219 filed Jan. 8, 2013, which is incorporated herein by reference in its entirety.

### TECHNICAL FIELD

Embodiments generally relate to the field of electronic devices, and, more particularly, to electronic alignment of optical signals.

### BACKGROUND

Optical information channels typically use various types of optical lenses to focus or collimate a light beam to couple a light signal from one media or device into the next media or device. For example, the light emitting area of, for example, a vertical-cavity surface-emitting laser (VCSEL) to the end surface of a multimode fiber (MMF), and from an end of the fiber to a photo-sensitive area of a photo sensor, such as a photodiode.

Optical communications may include using mediums such as optical fiber or free space to transfer optical signals in either analog or digital signal format. In general, the higher cost for an optical link in comparison to copper media (a wired connection or other electrical connection) is generally considered a premium cost for the higher performance capability of the optical link in terms of speed and reach length. Developments in industry, including the consumer electronics industry, have included the adoption of active optical cables (AOCs) to provide high-speed, high performance interconnection with a potential for reduced costs, particularly if such technology is deployed widely.

However, such conventional devices and systems require a high degree of mechanical precision to enable the optical coupling with a terminal connection, and thus are costly to produce. Conventional fiber optic techniques employing optical lenses in general are costly, inefficient, and complex mainly due to precision mechanical alignment for optical fiber coupling to a light source (such as VCSEL) and to a sink (such as a optical signal detector).

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates an implementation of an optical link system;

FIG. 2 is an illustration of an embodiment of an optical link system including electronic alignment of optical signals;

FIG. 3 is an illustration of an optical signal detector according to an embodiment;

FIG. 4 is an illustration of an embodiment of an optical link system with a focused optical signal;

FIG. 5 is an illustration of an embodiment of an optical link system with a de-focused optical signal;

FIG. 6 is illustrates components of a network computer device employing an embodiment;

FIG. 7A is an illustration of a conventional optical link;

FIG. 7B is an illustration of an embodiment of an optical link without an optical lens function;

FIG. 8 is an illustration of an embodiment of an optical link without an optical lens function;

FIG. 9 illustrates timing diagrams for processing of photodiode signals according to an embodiment of an optical link;

FIG. 10 illustrates a connection for high-speed optical fiber according to an embodiment; and

FIGS. 11A and 11B illustrate a connected optical link according to an embodiment.

### SUMMARY

Embodiments are generally directed to electronic alignment of optical signals.

In a first aspect, an embodiment of an apparatus includes an array of photo sensors; a bus coupled with the array, wherein the bus includes detection circuitry for each photo sensor of the array to generate a signal in response to the photo sensor receiving an optical signal; and a processing component to process a group of signals, the group of signals being signals generated by the detection circuitry for a subset of the photo sensors in response to the photo sensors receiving the optical signal, to generate an output signal.

In a second aspect, a method includes receiving an optical signal at an optical signal detector, the optical signal detector including photo sensors, the optical signal being received by a subset of the photo sensors; processing a group of signals generated by the subset of photo sensors; and based on the processing of the group of signals generated by the subset of photo sensors, producing an output signal.

### DETAILED DESCRIPTION

Embodiments are generally directed to electronic alignment of optical signals.

In some embodiments, an apparatus, system, or method provides for an optical link with electronic alignment of optical signals, the apparatus, system, or method allowing for high-speed operation requiring only low precision construction.

Conventional optical communication techniques are designed to maintain high-speed operation for an optical fiber link detector (for example, a photo-detector usually made by a compound semiconductor), and may include implementation of a very small photosensitive area in a detector to reduce the resistance-capacitance (RC) time constant of a circuit. In order to achieve this goal, an optical lens is made to focus the signal to a defined optical two-dimensional plane such that the signal-to-noise ratio is made sufficiently enough to guarantee the given performance requirement. For example, in a conventional implementation a 10 Gbps optical signal detector may have a sensing area that has a diameter of less than 50 μm. This size of sensing area is generally too small to couple with a low cost, general-purpose commercial plastic optical fiber (POF). Premium multimode fiber and similar material has comparable size and can provide decent coupling efficiency, but the construction of communication link devices requires high precision costs (including, for example, precise mechanical alignment requirements).

In one embodiment, optical focusing process may be removed wholly or in part from the system, while an equivalent process is provided in an electrical domain using an “electronic lens” semiconductor IC (integrated circuit), such as where the circuit may facilitate digital signal processing in the electrical domain after performing spatial and time domain sampling of the optical signal in a transmission medium either in free space or (optically) wired space.

In some embodiments, an optical fiber (such as glass or plastic optical fiber may be attached to an EO (electronic-optical) converter, such as laser, light-emitting diode (LED), a secondary light encoder such as an on-off modulator, or other such device, as a communication source.

In some embodiments, a mechanical precision for the alignment required by the electrical lens specification is reduced, as a part of an overall tolerance specification of the link. In an example, a conventional optical apparatus or system may require a precision tolerance in the range of 10 μm to provide proper alignment, and such tolerance may be increased to a value of, for example, 100 μm or greater depending on the number of photodiode cells in an implementation of an optical link.

In another embodiment, optical fiber (such as glass or plastic optical fiber) may be attached to an optical-electronic (OE) converter, such as photodiode or other photo senor, as a communication sink with a reduced precision alignment tolerance because of the electrical lens specification, resulting in an overall reduced tolerance specification of the link. In some embodiments, an electrical signal may be sent to the laser without the need for a high precision optical alignment for lens focusing, and a received electrical signal may be converted from the optical domain without the need for a high precision optical alignment for lens focusing.

In some embodiments, a semiconductor photodiode sensing surface or other photo sensing surface may be sub-divided in multiple areas (which may hereinafter be referred to as an MPA (Monolithic Photodiode Array)), where each sub-divisional area include its own detection circuitry, and, after the OE conversion, each signal may be manipulated for functions of (1) focusing light intensity and (2) directing a optical signal to a particular location. For implementing function (1) (focusing light-intensity), each of multiple impulse responses may be compared by a processing component, while an inverse FIR filter may be applied by the DSP method to input the optical signal. For implementing the function (1), focusing may be achieved by any low cost lens material, such as a ball lens. For implementing function (2) (locating the light signal), the dimensions of the sub-divisions are made sufficiently small so that consumer electronics manufacturers are not required to be concerned about precision tolerance of optical lens system alignment. Further, in case of misalignment, the signal falling onto the sensitive area may be added to the electronic lens (EL) while the signal may be processed through FIR filtering including an embedded inverse IR filter (IFIR), which can generate a meaningful flow of information as long as the light hits one of the sub-divisional photo-cell (which may depend on the photo-detector's dark current limit or sensitivity limit).

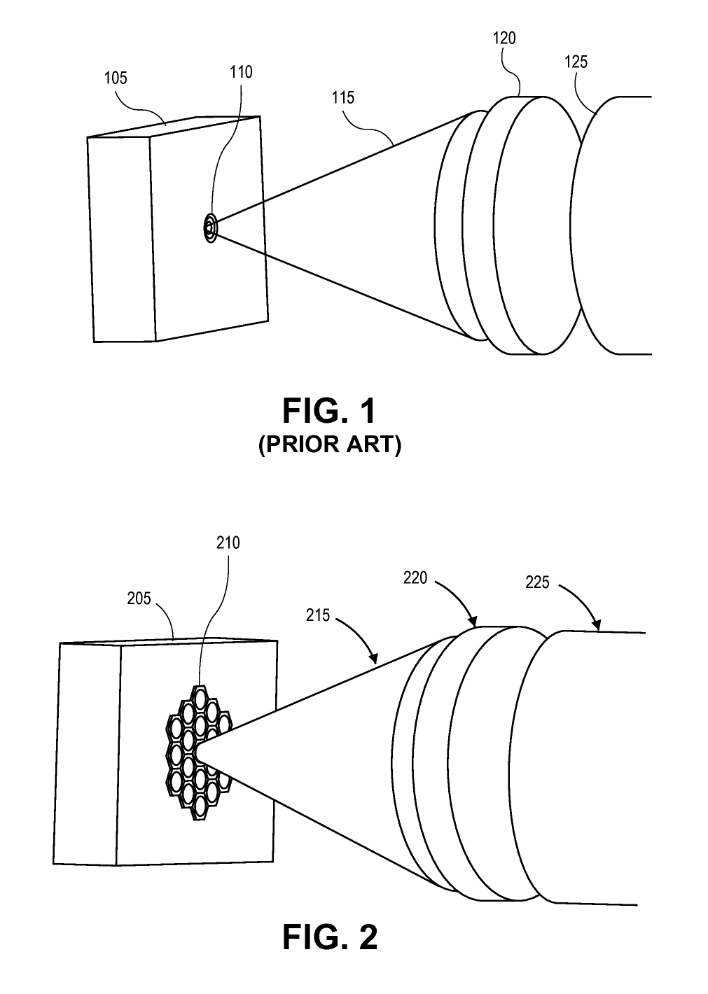

FIG. 1 illustrates an implementation of an optical link system. In this illustration, an apparatus includes an optical fiber 125 such as a POF with an optical lens 120 to provide focusing of an optical signal 115 onto the sensing area 110 of an optical signal detector 105. Without precise focusing, the numerical aperture (NA) of the fiber may induce significant output beam divergence.

However, there are at least two fundamental disadvantages associated with the conventional optical link system illustrated in FIG. 1:

(1) The NA needs to be handled in a manner to control the divergence of the optical beam from the optical fiber end, and thus one or more “lenses” are introduced into the system to provide a certain m:1 spatial beam convergence, and thus creating precision focusing costs.

(3) Even if the beam output from an optical fiber is well focused (such as 20:1) within its desired spot diameter, there is a problem in locating the resulting light spot onto the desired area of photo-detector within the mechanical tolerance in x-y coordinates. This precision alignment issue for conventional devices presents a serious engineering challenge, especially under cost-driven consumer electronics manufacturing constraints.

In some embodiments, an apparatus provides a high-speed link that may be produced at lower cost by introducing a new receiver (e.g., sink) device and architecture providing electronic alignment of optical signals, while maintaining low cost and high performance for the optical fiber connection.

Conventional techniques may use (1) a single-mode fiber (SMF) (which is expensive and requires a tight mechanism for alignment), (2) a large area photodiode and apply equalization to the combined signal to correct for the modal dispersion (where equalization boots a high frequency noise and degrades the sensitivity, equalization beyond a certain amount may be impractical and limit the bitrate of the received signal), and (3) a multimode fiber, but use a small detector to restrict the number of received modes (while requiring a tight mechanical alignment).

In some embodiments, an apparatus or system provides for reducing dispersion in a received optical signal from a multimode optical fiber while having relaxed mechanical alignment requirements. In some embodiments, spatial separation of a number of small photo sensors may be used in a detector plane to provide a distinct response for the individual fiber propagation modes, allowing recombination with less equalization. Embodiments further provide electronic signal processing handle received signals, where the signal processing may include selecting a single detector of a plurality of M detectors receiving an optical signal; selecting a subset of K detectors out of the total M and forming a simple sum to optimize metrics (such as total combined power, flatness of frequency response, etc.); generating a weighted linear sum of the outputs; or making a finite impulse response (FIR) combination of the inputs using analog or digital processing methods.

In some embodiments, the premium costs of precision engineering overhead for an optical link are reduced by removing or reducing mechanical precision requirements, and facilitating electrical and automatically adjustable semiconductor device for mass production. In some embodiments, the conventional precision cost burden relating to optical communication physical media is alleviated by providing multiple cells in a semiconductor photodiode, whereby the arbitrary aim of an optical signal can be received and the signal processed by one or more of cells that happen to be hit by the optical ray. In some embodiments, by providing such multiple high-speed photodiode cells, a stray ray can be captured and used as a main signal by electrically selecting the aligned photodiode cell(s).

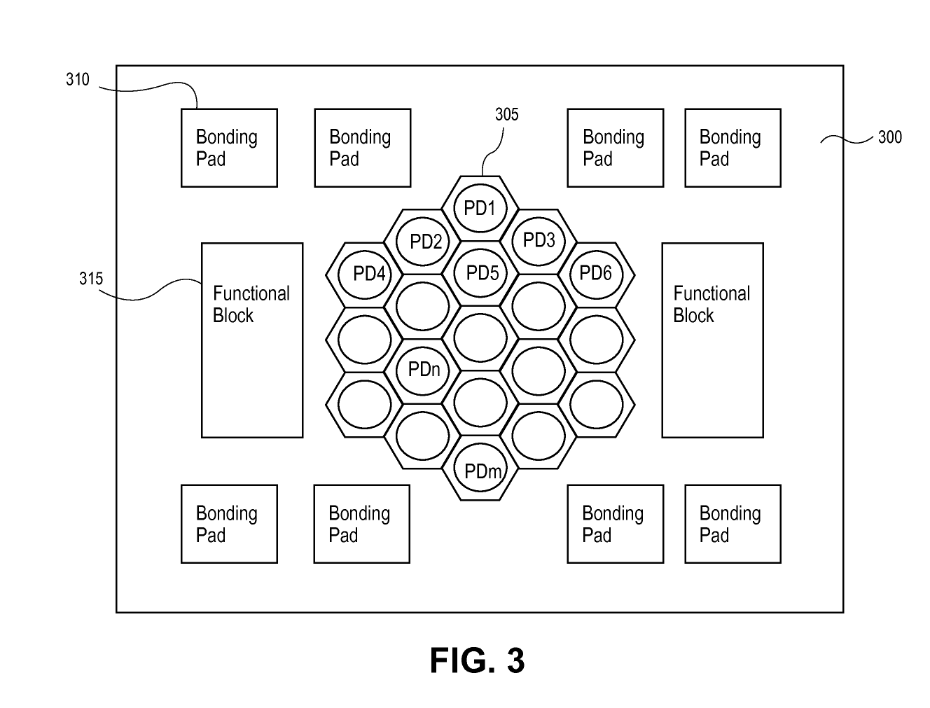

FIG. 2 is an illustration of an embodiment of an optical link system including electronic alignment of optical signals. In this illustration, an apparatus includes an optical fiber 225 with an optical lens 220 to provide focusing of an optical signal 215. In some embodiments, an optical signal detector 205 includes an array of photo sensors, such as array of photodiodes 210. While the figures herein generally illustrate photodiodes, embodiments are not limited to photodiodes, and may utilize any photo sensor technology capable of generating a current or voltage signal in response to receiving an optical signal. The optical signal detector 205 may be constructed as illustrated in FIG. 3. In contrast with FIG. 1, the sensing area is greater than the area of the optical signal 215, and thus only a subset of the cells of the photodiode array 210 are impacted by the optical signal 215. In some embodiments, the optical signal detector 205 provides electronic alignment of optical signals to handle the optical signal that only impacts a subset of one or more photodiodes of the array of photodiodes, where the subset of photodiodes may be any grouping of photodiodes in the array.

While FIG. 2 and other figures herein illustrate embodiments including an optical lens to focus a received optical signal, the lens is an optional component, and embodiments are not limited to optical link systems that include a lens for focusing the optical signal. In some embodiments, an optical signal from an optical fiber may impact an optical sensor without the optical signal passing through an optical lens.

FIG. 3 is an illustration of an optical signal detector according to an embodiment. In some embodiments, an optical signal detector 300 includes an array of multiple photodiodes (or other photo sensors) 305, indicated as PD1 through PDm. In some embodiments, the array of photodiodes is coupled with a bus including detection circuitry for each photodiode to generate a detection signal in response to receiving an optical signal. In some embodiments, each photodiode is connected with a signal circuitry to generate a signal output. The optical signal detector 300 further includes one or more bonding pads 310 and one or more functional blocks 315. In some embodiments, the functional blocks include processing components to process signals generated in response to optical signals being received by a subset of one or more of the photodiodes of the array of photodiodes, and provide for the electronic adjustment of the axis of the received optical signal. In some embodiments, the bus further includes an array of switches to select signals of one or more photodiodes for generation of an output signal.

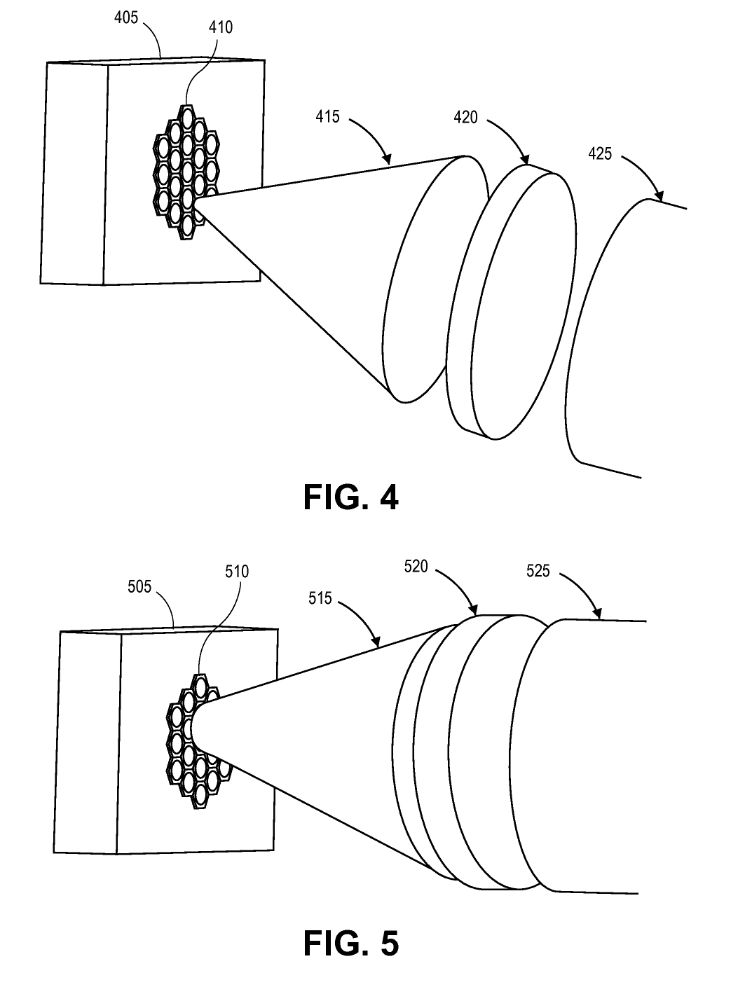

FIG. 4 is an illustration of an embodiment of an optical link system with a focused optical signal. In this illustration, an apparatus includes an optical fiber 425 with an optional optical lens 420 to provide focusing of an optical signal 415. In some embodiments, an optical signal detector 405 includes an array of photodiodes (or other photo sensors) 410, where the optical signal 415 is focused on a subset including a single photodiode or a small grouping of adjacent photodiodes of the array. Stated in another way, the area of the focused signal spot may be less than or equal to the area of a photodiode. As illustrated in FIG. 4, the one or more photodiodes that receive the optical signal may be located anywhere in the array, wherein the location may be a function of physical dislocation of the optical fiber 425 and lens 420 in a particular optical link arrangement.

FIG. 5 is an illustration of an embodiment of an optical link system with a de-focused optical signal. In this illustration, an apparatus includes an optical fiber 525 with an optional optical lens 520 to provide focusing of an optical signal 515, where the optical signal is defocused to direct an optical signal onto multiple photodiodes. In some embodiments, an optical signal detector 505 includes an array of photodiodes (or other photo sensors) 510, where the optical signal is focused on a subset of the array 510, where the subset includes multiple photodiodes. Stated in another way, the area of the focused optical spot is greater than the area of a photodiode, and may be equal to the area of multiple photodiodes. As with FIG. 4, the photodiodes that receive the optical signal may be located anywhere in the array, wherein the location may be a function of physical dislocation of the optical fiber 525 and lens 520 in a particular optical link arrangement.

In some embodiments, an optical signal detector is manufactured using semiconductor integrated circuit (IC) manufacturing processes, and includes a two-dimensional array of photodiodes (also referred to as “diode array” or simply a “cell”) or other photo sensors. In some embodiments, the optical signal detector operates as a high-speed signal detector. The photodiode array may be implemented on a bare die of a semiconductor and packaged with optically transparent window or transparent passivation through which the array may receive an incoming optical signal, where the optical signal may have a finite spot size that may cover any number of cells. In some embodiments, the array of cells may be spread in any pattern, and may be either adjacent to each other or spread sporadically, as illustrated in FIG. 5.

In some embodiments, an array of photodiodes may be exposed to an optical signal emitted out from a fiber (POF, MMF or SMF) that is aligned with a photodiode within a known mechanical x-y positioning tolerance. This mechanical tolerance is an important parameter for the overall manufacturing cost for an optical link system, particular with regard to consumer electronics, mobile market products, and other mass produced products. Embodiments facilitate elimination or reduction of the precision cost burden by providing multiple cells in a semiconductor optical signal detector whereby an arbitrary aim of the optical signal can be received and the signal processed by one or more of the cells that are impacted by the optical signal. In some embodiments, a stray signal ray may be used as a main signal by electrically selecting the one or more impacted photodiode cells.

In some embodiments, a minimum precision threshold for an optical link system may be limited to a z-axis control, where the z-axis is along the length of an optical fiber (such as focal length control), thus making the optical product manufacturing relatively simple and cost-efficient. In some embodiments, z-axis control may include one of the following focusing regimes:

(1) Focusing the optical ray for an image spot size to approximately the same size or smaller as one cell in the array by, for example, controlling the approximate focal length within the tolerance range or threshold relating to a given mechanical process, as illustrated in FIGS. 2 and 4. This may be indicated as “m:1” focusing, where the focus is on one of m photodiodes of an array.

(2) Focusing the optical ray for an image spot size that larger than a size of a cell in the array by controlling the approximate focal length, as illustrated in FIG. 5, within a tolerance range or threshold relating to a given mechanical process. This may be indicated as “m:n” focusing, where the focus is on n photodiodes of the m photodiodes of an array.

In some embodiments, where a focusing regime is (1), a functional block as illustrated in FIG. 3 may be employed and used to handle the receipt of received signals at one or more photodiodes. In some embodiments, the location of the signal spot may be determined by, for example, x-y decision circuitry by using maximum power detection logic (such as an algorithm) through a power level comparison. In some embodiments, a power level comparison may utilize a dynamic received power monitor (DRPM). In some embodiments, a high-speed analog switch may select which cell or cells out of the array may be turned on and have a subsequent signal circuitry enabled and run, where the signal circuitry may include as a trans-impedance amplifier (TIA), an output buffer or de-serializer, or other similar circuitry.

In some embodiments, where a focusing regime is (2), a parallel input of a de-focused light spreads to an area broader than a single cell area. In some embodiments, a functional block of the optical signal detector may include a filter to provide time-transversal of incoming signals.

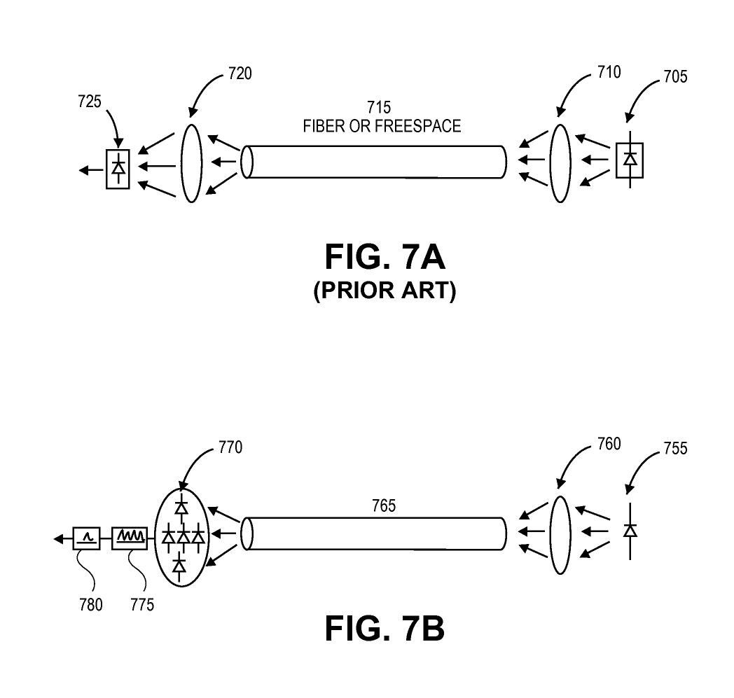

FIG. 7A is an illustration of a conventional optical link. In this illustration, an optical signal source 705 generates an optical signal, the optical signal being directed by a first optical lens element 710 to be carried via a medium 715 such as an optical fiber or free space (such as in circumstances in which the distance for the optical signal is very short). The optical signal then is focused by a second optical lens element 720 on a sensing area of an optical signal detector 725. However, the conventional optical link requires high precision construction to provide for the focusing of the optical signal on the optical signal detector.

Referring to FIGS. 7B-9, in some embodiments, optical link mechanisms provide for replacement of at least a portion of an optical lens function by employing an electrical signal process. This may be utilized, for example, for consumer optical data links, where some or all of the optical lens function is provided by a semiconductor device by its signal process capability, either in digital or analog manner. In the consumer electronics environment, cost is an extremely important factor, and, although the industry has attempted to produce an optical system (including, for example, the lens system) that is cost-efficient, the lens systems continues to cost significantly more than copper wire systems.

FIG. 7B is an illustration of an embodiment of an optical link without an optical lens function. In this illustration, an optical signal source 755 generates an optical signal, the optical signal being directed by a first lens element 760 to be carried via a medium 765 such as an optical fiber or free space. In some embodiments, the optical signal is directed to an array of optical diodes 770. In some embodiments, the array of optical diodes 770 produces multiple temporally displaced signals 775, wherein the optical signal detector processes such signals to generate an output signal 780. The optical signal source may be, for example, a VCSEL. However, embodiments are not limited to a particular source technology, and may include, for example, any edge emitting laser diode, such as a DFB (distributed feedback) laser diode, or the output of an optical modulator or intermediate optical media stage at the optical fiber coupling.

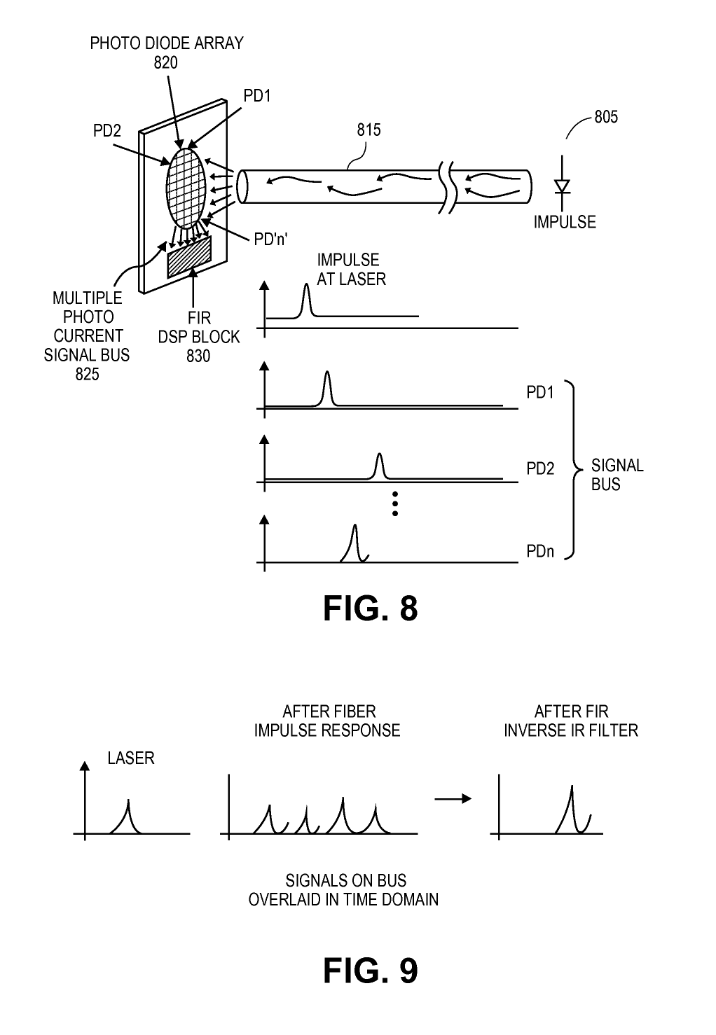

FIG. 8 is an illustration of an embodiment of an optical link without an optical lens function. In this illustration, an optical signal source 805 generates an optical signal, which is illustrated as a signal impulse. The light signal generated by the impulse is carried by a medium 815, such as an optical fiber, where the light signal is directed onto an optical signal detector including a photodiode array 810, where the light signal will impact multiple photodiodes. The array of photodiodes are indicated as PD1, PD2, and continuing through PDn. In some embodiments, the optical signal detector further includes a multiple photo current signal bus 825 to carry the current signals generated by the multiple photodiodes that are impacted by the light signal, the signal bus providing the current signals to an FIR (Finite Impulse Response) DSP (Digital Signal Processing) filter block. In some embodiments, the array of optical diodes 820 produces multiple temporally displaced signals, with the signal for the original impulse and with the signals for PD1, PD2, and PD3 being illustrated. In some embodiments, the FIR DSP block operates to process the signals of the multiple photodiodes to generate an output signal.

FIG. 9 illustrates timing diagrams for processing of photodiode signals according to an embodiment of an optical link. In this illustration, a laser impulse is shown as signal that is transmitted via an optical link to an optical signal detector, such as illustrated in FIG. 8. As a result of the spatial displacement of the signal impacting multiple photodiodes at varying angles and distances, the resulting current signals are temporally displaced, as shown in FIG. 9 as signals on the bus overlaid in the time domain. In some embodiments, an FIR function, such as an operation of the FIR DSP block 830 illustrated in FIG. 8, is performed on the displaced signals, resulting in an output signal representing the impulse signal, the output signal illustrated as after FIR inverse IR filter.

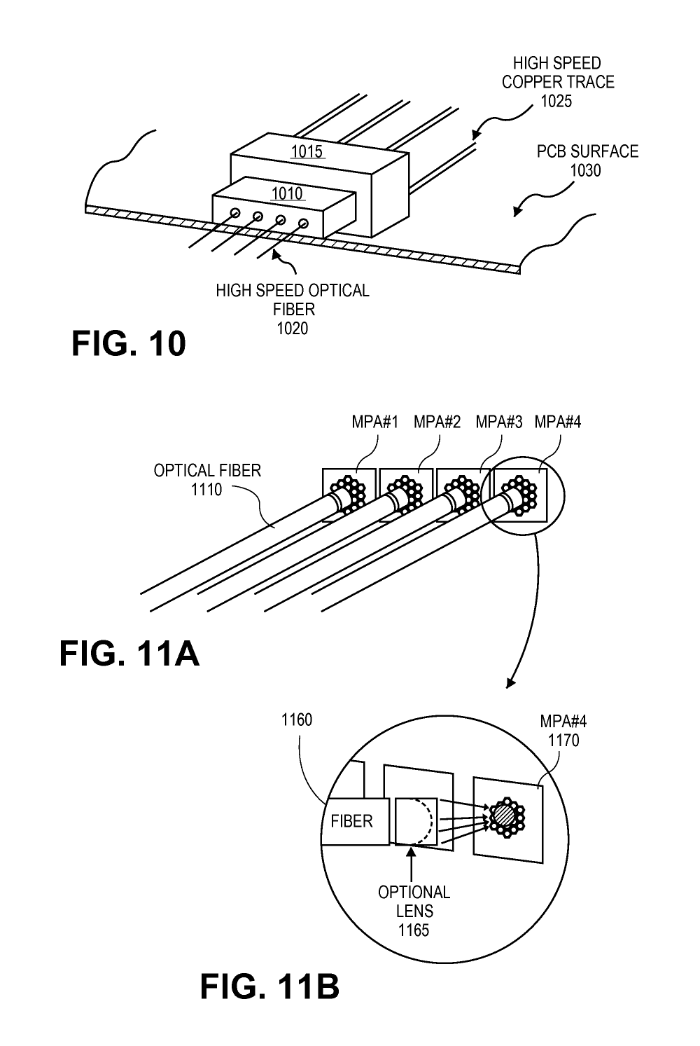

FIG. 10 illustrates a connection for high-speed optical fiber according to an embodiment. In some embodiments, a link includes physical connectors to connect optical fiber to a copper trace for transfer of received signals. In this illustration, multiple high-speed fibers 1020 are connected to a first fiber array connector 1010, where the first connector in this illustration may be a male connector. The first fiber array connector 1010 may be mated with a second fiber optic array connector 1015, which may be a female connector. In some embodiments, the first connector and second connector when connected provide a optical link, such as illustrated in FIG. 2 or FIG. 4, and include an embodiment of an optical signal detector, such as illustrated in FIG. 3.

FIGS. 11A and 11B illustrate a connected optical link according to an embodiment. FIG. 11A provides a “see-through” illustration of an embodiment of an optical link such as illustrated in FIG. 10 with the first connector 1010 and the second connector 1015 coupled together. In this illustration, multiple optical fibers (four optical fibers in this example) are positioned such that an output end of such optical fibers direct an optical signal on a photodiode array of an optical signal detector, indicated as MPA#1, MPA#2, MPA#3, and MPA#4.

FIG. 11B provides a magnified view of the optical fiber and optical signal detector structure. In this illustration, an optical fiber 1160 delivers an optical signal to the photodiode array MPA#4 1170. In some embodiments, the connection may include an optional lens to focus the optical signal on the photodiode array. In some embodiments, the apparatus includes components to provide for handling of the signals produced by one or more photodiodes of the array in response to the optical signal delivered by the optical fiber 1160.

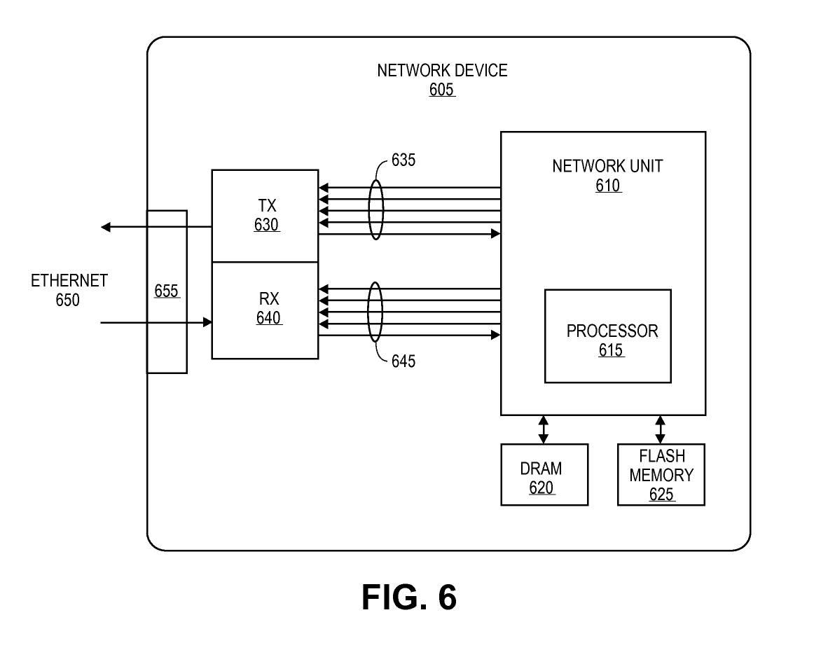

FIG. 6 illustrates components of a network computer device 605 employing an embodiment. In this illustration, a network device 605 may be any device in a network, including, but not limited to, a computing device, a network computing system, a television, a cable set-top box, a radio, a Blu-ray player, a DVD player, a CD player, an amplifier, an audio/video receiver, a smartphone, a Personal Digital Assistant (PGA), a storage unit, a game console, or other media device. In some embodiments, the network device 605 includes a network unit 610 to provide network functions. The network functions include, but are not limited to, the generation, transfer, storage, and reception of media content streams. The network unit 610 may be implemented as a single system on a chip (SoC) or as multiple components.

In some embodiments, the network unit 610 includes a processor for the processing of data. The processing of data may include the generation of media data streams, the manipulation of media data streams in transfer or storage, and the decrypting and decoding of media data streams for usage. The network device may also include memory to support network operations, such as Dynamic Random Access Memory (DRAM) 620 or other similar memory and flash memory 625 or other nonvolatile memory. Network device 605 also may include a read only memory (ROM) and or other static storage device for storing static information and instructions used by processor 615.

A data storage device, such as a magnetic disk or optical disc and its corresponding drive, may also be coupled to network device 605 for storing information and instructions. Network device 605 may also be coupled to an input/output (I/O) bus via an I/O interface. A plurality of I/O devices may be coupled to I/O bus, including a display device, an input device (e.g., an alphanumeric input device and or a cursor control device). Network device 605 may include or be coupled to a communication device for accessing other computers (servers or clients) via external data network. The communication device may comprise a modem, a network interface card, or other well-known interface device, such as those used for coupling to Ethernet, token ring, or other types of networks.

Network device 605 may also include a transmitter 630 and/or a receiver 640 for transmission of data on the network or the reception of data from the network, respectively, via one or more network interfaces 655. The transmitter 630 or receiver 640 may be connected to a wired transmission cable, including, for example, an Ethernet cable 650, a coaxial cable, or to a wireless unit. The transmitter 630 or receiver 640 may be coupled with one or more lines, such as lines 635 for data transmission and lines 645 for data reception, to the network unit 610 for data transfer and control signals. For illustration, there are four lines from the network unit 610 to the transmitter 630 and a reverse line from the transmitter 630 to the network unit 610, and four lines from the receiver 640 to the network unit and a reverse line from the network unit 610 to the receiver 640. Additional or alternate connections may also be present. The network device 605 also may include numerous components for media operation of the device, which are not illustrated here. In some embodiments, the network interfaces 655 include an optical link providing for electronic alignment of optical signals, such as elements illustrated in FIGS. 2, 4, 5, 7B, 8, and 9. In some embodiments, the network interfaces include an optical signal detector, such as illustrated in FIG. 3. In some embodiments, the network interfaces include an optical connector, such as illustrated in FIGS. 10, 11A, and 11B.

Network device 605 may be interconnected in a client/server network system or a communication media network (such as satellite or cable broadcasting). A network may include a communication network, a telecommunication network, a Local Area Network (LAN), Wide Area Network (WAN), Metropolitan Area Network (MAN), a Personal Area Network (PAN), an intranet, the Internet, etc. It is contemplated that there may be any number of devices connected via the network. A device may transfer data streams, such as streaming media data, to other devices in the network system via a number of standard and non-standard protocols.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. There may be intermediate structure between illustrated components. The components described or illustrated herein may have additional inputs or outputs that are not illustrated or described. The illustrated elements or components may also be arranged in different arrangements or orders, including the reordering of any fields or the modification of field sizes.

The present invention may include various processes. The processes of the present invention may be performed by hardware components or may be embodied in computer-readable instructions, which may be used to cause a general purpose or special purpose processor or logic circuits programmed with the instructions to perform the processes. Alternatively, the processes may be performed by a combination of hardware and software.

Portions of the present invention may be provided as a computer program product, which may include a computer-readable non-transitory storage medium having stored thereon computer program instructions, which may be used to program a computer (or other electronic devices) to perform a process according to the present invention. The computer-readable storage medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/computer-readable medium suitable for storing electronic instructions. Moreover, the present invention may also be downloaded as a computer program product, wherein the program may be transferred from a remote computer to a requesting computer.

Many of the methods are described in their most basic form, but processes may be added to or deleted from any of the methods and information may be added or subtracted from any of the described messages without departing from the basic scope of the present invention. It will be apparent to those skilled in the art that many further modifications and adaptations may be made. The particular embodiments are not provided to limit the invention but to illustrate it.

If it is said that an element “A” is coupled to or with element “B,” element A may be directly coupled to element B or be indirectly coupled through, for example, element C. When the specification states that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification refers to “a” or “an” element, this does not mean there is only one of the described elements.

An embodiment is an implementation or example of the invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects.

The following examples describe certain embodiments:

In some embodiments, an apparatus includes: an array including a plurality of photo sensors; a bus coupled with the array, the bus including detection circuitry for each photo sensor to generate a signal in response to the photo sensor receiving an optical signal; and a processing component to process a group of signals, the group of signals being signals generated by the detection circuitry for a subset of the photo sensors in response to the photo sensors receiving the optical signal, to generate an output signal.

In some embodiments, the photo sensors of the array of the apparatus are photodiodes.

In some embodiments, the bus further includes an array of switches to select signals of one or more photo sensors for the generation of the output signal.

In some embodiments, the processing component receives the group of signals and electrically selects one of the group of signals as a main photo sensor signal to generate the output signal. In some embodiments, selecting one of the group of signals includes comparing a power of each of the group of signals.

In some embodiments, the processing component includes a filter for filtering of the group of signals to generate the output signal. In some embodiments, the filter is to filter temporal displacement of each signal of the group of signals. In some embodiments, the filter is an FIR (Finite Impulse Response) filter.

In some embodiments, the apparatus further includes an optical lens to focus the optical signal on the array of photo sensors.

In some embodiments, the optical lens generates an optical spot with an area that is less than or equal to an area of a photo sensor. In some embodiments, the optical lens generates an optical spot with an area that is greater than an area of a photo sensor.

In some embodiments, the photo sensors of the array are adjacent to each other. In some embodiments, the photo sensors of the array are separated from each other in a pattern.

In some embodiments, a method includes: receiving an optical signal at an optical signal detector, the optical signal detector including a plurality of photo sensors, the optical signal being received by a subset of the photo sensors; processing a group of signals generated by the subset of photo sensors; and based on the processing of the group of signals generated by the subset of photo sensors, producing an output signal.

In some embodiments, processing the group of signals generated by the subset of photo sensors includes comparing a power of each signal of the group of signals.

In some embodiments, the method further includes selecting one of the group of signals as a main photo sensor signal based on the comparison of the power of each signal of the group of signals.

In some embodiments, processing the group of signals generated by the subset of photo sensors includes filtering temporal displacement of each signal of the group of signals. In some embodiments, the filtering includes applying FIR (Finite Impulse Response) filtering to the group of signals.

In some embodiments, an integrated circuit includes: a photodiode sensing surface, the surface being divided into a plurality of areas, each area being coupled with a detection circuitry for the area; and one or more functional blocks, the one or more functional blocks including one or more processing components to process a group of signals generated by the detection circuitry for a subset of one or more of the areas of the photodiode sensing surface in response to the subset of the areas receiving optical signals. In some embodiments, the one or more processing components provide for electronic adjustment of an axis of the received optical signals.

In some embodiments, the processing components include a component to select a signal of the group of signals for generation of an output signal based at least in part on which area of the subset of areas produces a greatest amount of power in response to receiving the optical signals.

In some embodiments, the processing components include a filter to provide time transference of the signals of the group of signals.

In some embodiments, the optical signals are focused on the photodiode sensing surface via an optical lens.

In some embodiments, the optical signals are received by the photodiode sensing surface directly from an optical fiber.

In some embodiments, the photodiode sensing surface is implemented on a semiconductor die, the integrated circuit being packaged with an optically transparent window for the photodiode sensing surface.

What is claimed is:

1. An apparatus comprising:
an array including a plurality of photo sensors;
a bus coupled with the array, the bus including detection circuitry for each photo sensor to generate a signal in response to the photo sensor receiving an optical signal; and
a processing component to process a group of signals, the group of signals being signals generated by the detection circuitry for a subset of the photo sensors in response to the photo sensors receiving the optical signal, to generate an output signal.

2. The apparatus of claim 1, wherein the photo sensors are photodiodes.

3. The apparatus of claim 1, wherein the bus further includes an array of switches to select signals of one or more photo sensors for the generation of the output signal.

4. The apparatus of claim 1, wherein the processing component receives the group of signals and electrically selects one of the group of signals as a main photo sensor signal to generate the output signal.

5. The apparatus of claim 4, wherein selecting one of the group of signals includes comparing a power of each of the group of signals.

6. The apparatus of claim 1, wherein the processing component includes a filter for filtering of the group of signals to generate the output signal.

7. The apparatus of claim 6, wherein the filter is to filter temporal displacement of each signal of the group of signals.

8. The apparatus of claim 7, wherein the filter is an FIR (Finite Impulse Response) filter.

9. The apparatus of claim 1, further comprising an optical lens to focus the optical signal on the array of photo sensors.

10. The apparatus of claim 9, wherein the optical lens generates an optical spot with an area that is less than or equal to an area of a photo sensor.

11. The apparatus of claim 9, wherein the optical lens generates an optical spot with an area that is greater than an area of a photo sensor.

12. The apparatus of claim 1, wherein the photo sensors of the array are adjacent to each other.

13. The apparatus of claim 1, wherein the photo sensors of the array are separated from each other in a pattern.

14. A method comprising:
receiving an optical signal at an optical signal detector, the optical signal detector including a plurality of photo sensors, the optical signal being received by a subset of the photo sensors;
processing a group of signals generated by the subset of photo sensors; and
based on the processing of the group of signals generated by the subset of photo sensors, producing an output signal.

15. The method of claim 14, wherein processing the group of signals generated by the subset of photo sensors includes comparing a power of each signal of the group of signals.

16. The method of claim 15, further comprising selecting one of the group of signals as a main photo sensor signal based on the comparison of the power of each signal of the group of signals.

17. The method of claim 14, wherein processing the group of signals generated by the subset of photo sensors includes filtering temporal displacement of each signal of the group of signals.

18. The method of claim 17, wherein the filtering includes applying FIR (Finite Impulse Response) filtering to the group of signals.

19. An integrated circuit comprising:
a photodiode sensing surface, the surface being divided into a plurality of areas, each area being coupled with a detection circuitry for the area; and
one or more functional blocks, the one or more functional blocks including one or more processing components to process a group of signals generated by the detection circuitry for a subset of one or more of the areas of the photodiode sensing surface in response to the subset of the areas receiving optical signals;
wherein the one or more processing components provide for electronic adjustment of an axis of the received optical signals.

20. The integrated circuit of claim 19, wherein the processing components include a component to select a signal of the group of signals for generation of an output signal based at least in part on which area of the subset of areas produces a greatest amount of power in response to receiving the optical signals.

21. The integrated circuit of claim 19, wherein the processing components include a filter to provide time transference of the signals of the group of signals.

22. The integrated circuit of claim 19, wherein the optical signals are focused on the photodiode sensing surface via an optical lens.

23. The integrated circuit of claim 19, wherein the optical signals are received by the photodiode sensing surface directly from an optical fiber.

24. The integrated circuit of claim 19, wherein the photodiode sensing surface is implemented on a semiconductor die, the integrated circuit being packaged with an optically transparent window for the photodiode sensing surface.
